(19) United States
(12) Patent Application Publication
(10) Pub. No.: US 2010/0217610 A1
(43) Pub. Date: Aug. 26, 2010

(54) Queue Management System

(75) Inventors: Chu Suan Ang, UEP Subang Jaya (MY); Kun Won Tang, Subang Jaya (MY)

Correspondence Address: THE H.T. THAN LAW GROUP, WATERFRONT CENTER SUITE 560, 1010 WISCONSIN AVENUE NW, WASHINGTON, DC, 20007, US

(73) Assignee: General Microsystems SDN. BHD, UEP Subang Jaya (MY)

(21) Appl. No.: 12/160,365

(22) PCT Filed: Sep. 20, 2007
(86) PCT No.: PCT/MY07/00064

§ 371 Date: Jul. 9, 2008

(30) Foreign Application Priority Data
Jun. 29, 2007 (MY) PI20071035

(51) Int. Cl. G06Q 10/00; G06F 7/04; G06F 3/041

(52) U.S. Cl. 705/1.1; 340/5.82; 345/173; 235/380

(57) ABSTRACT

A system and method are provided that enable optimised content to be displayed to customers being served at service positions in an establishment. On entering the establishment, the identity of a customer is captured and the customer is provided with a customer reference. Content may then be associated with the customer reference in dependence on the customer's identity and when the customer is called to a service position the content is displayed to the customer.

### FIELD OF THE INVENTION

The present invention relates to a system for managing customers in a queue waiting for service at a plurality of service positions such as in a bank, insurance company, and other business establishments.

### BACKGROUND TO THE INVENTION

Queue systems for managing customer queues at a plurality of service positions in establishments are previously known.

U.S. Pat. No. 3,641,553 discloses a registering and calling system for waiting numbers wherein each customer takes a turn number upon arrival at the establishment. Customers are called to a free service position to be served when their turn comes up.

U.S. Pat. No. 4,675,647 discloses a system for determining a queue sequence for serving customers at a plurality of service positions. This system is similar to U.S. Pat. No. 3,641,553 with the added novelty that it allows customers to select a particular service position at which they desire to be served. Customers are called to a free service position to be served when their turn comes up, taking into consideration their selected service position, if any.

U.S. Pat. No. 6,059,184 discloses a turn number system and method capable of giving priority to specific customers. A customer selects a service type and obtains a turn number for the selected service type. The novelty of this system is that customers whom the establishment wishes to identify and give priority to are provided with individual codes stored on magnetic cards or the like. When a customer with identity code is called to a service position, information pertaining to the customer is retrieved from a database and presented to the teller at that service position.

None of the prior art queue systems is capable of delivering customized electronic information to and getting immediate response from targeted customers being served at service positions, a feature desirable by many business establishments, as explained below.

Very often, business establishments with large customer base such as banks would like to sell other products to their existing customers, a concept generally known as “cross selling.” For example, a bank may want to promote unit trust or other investment products to its customers who have consistently maintained a high credit balance in their accounts over the past six months. Likewise, customers with a good track record on monthly loan repayment may be targeted for credit card or other loan promotion. The conventional method used by business establishments to deliver customized advertisement to targeted customers is to mail printed promotional materials to the targeted customers. However, the success rate of this method is very low as customers usually do not bother to read such promotional materials. Furthermore, the cost of mass mailing is rather high. With the recent widespread use of internet banking, a more convenient method is now available whereby the customized advertisement is displayed on a webpage when a targeted customer logs on to the establishment's website to carry out an online transaction. This method has the added advantage over the conventional mass mailing method in that the customer can choose to respond to the advertisement immediately if he so wishes by, for example, clicking on the advertisement being displayed. However, this method has a drawback in that it is not able to reach customers who do not perform their transactions online.

It is therefore desirable for the establishment to be able to deliver customized advertisement to targeted customers who do not read printed promotional materials and do not perform online transactions. Preferably, it should be possible for the customers to immediately respond to the advertisement if he so wishes. Such a possibility exists when a targeted customer visits the establishment's premises to perform a transaction over the counter. When a customer is being served by a teller over the counter, he typically presents some forms or documents to the teller and then has to wait for a while for the teller to process his transaction. This idling time spent waiting for the teller to process his transaction presents the establishment with a golden opportunity to deliver customized advertisement to the customer and to solicit response from the customer.

### SUMMARY OF THE INVENTION

According to a first aspect of the present invention, there is provided a queue management system comprising: a dispenser adapted to acquire the identities of customers and to issue a customer reference for each customer, each customer reference representing the position of a respective customer within a queue; a control system adapted to associate content with each customer reference in dependence on the identity acquired for that customer reference; and, a service mechanism adapted to call the customer at the front of the queue to a service position and to display to that customer the content associated with that customer's customer reference at the service position.

According to a second aspect of the present invention, there is provided a method for managing a queue, the method comprising: acquiring the identities of a plurality of customers; issuing a customer reference for each customer, each customer reference representing the position of a respective customer within the queue; associating content with each customer reference in dependence on the identity acquired for that customer reference; calling the customer at the front of the queue to a service position; and, displaying the content associated with the customer reference of the customer at the front of the queue to that customer.

The present invention provides a queue management system capable of delivering customized electronic information to targeted customers being served at service positions in an establishment. As such, it provides opportunities for cross-selling in an efficient and effective manner in an environment previously incapable of offering this service.

A dispenser acquires the identities of customers entering the system, and also issues a customer reference to each customer indicating the position of the customer within the queue. The acquired identities are then used to associate appropriate content with each customer reference. When a customer reaches the front of the queue he or she is called to a service position and the content associated with that customer's customer reference is displayed to the customer.

The queue of the present invention may operate according to any appropriate queue discipline. For example, a first-in, first-out queue discipline may be adopted. Alternatively, other queue disciplines may be used. For example, customers may move to the front of the queue in dependence on their identity or the services they intend to utilise. Moreover, a customer's position in the queue may depend on the identity of that customer. For example, an elderly customer may be given priority and called ahead of others who arrive before him or her. In a system where there are a plurality of service positions, the queue discipline may depend upon which of the service positions the customer is being called to.

The service mechanism may take any appropriate form. For example, in a preferred embodiment, the service mechanism includes means at the service position for a teller to request a customer when the position is free, this request causing a physically distinct customer advising means to request the next-in-turn customer attend the service position. Alternatively, the service mechanism may comprise a central system that automatically requests customers attend the service position at the appropriate time. In general, one skilled in the art would recognise that a number of different arrangements for the service mechanism are possible. As such, the service mechanism may or may not comprise the service position.

Preferably, the content is interactive and sufficient means are provided for the customer to interact with the content. This allows the customers to immediately respond to the customized electronic information if they so wish. It also further enhances the appeal and effectiveness of the content delivered to the customer. Furthermore, such an arrangement allows for an efficient use of the time available to the customer and the establishment, enabling additional transactions to occur while the user is waiting at a service position. The generation of content may include the construction of unique content in dependence on the identity of the customer. Alternatively, it may comprise selection of content from a pre-existing database, the selection step occurring in dependence on the identity of the customer.

In some embodiments the control system may be linked to an external provide of content. For example, the control system may be linked to an external device containing information belonging to the establishment in which the queue system operates, and this information may be used to generate the content.

In the preferred embodiment of the present invention, the service mechanism calls the user by providing an indication (aurally and/or visually) that it is the turn of the individual holding the customer's customer reference to be served. Typically, the customer is aware of his or her customer reference having been provided with a physical ticket indicating the customer reference by the dispenser. Alternatively, the dispenser may provide a virtual ticket to an electronic device held by the customer by wired or wireless network connection. It is also envisaged that the dispenser may simply display the reference to the customer with it then being the customer's responsibility to remember the reference.

The present invention also allows for the service mechanism to call the customer in other ways. For example, because the identity of the customer is known, the service mechanism may use the name of the customer to indicate that it is their turn to be served.

In some preferred embodiments of the present invention, the customer is identified through measurement of biometric details. In other preferred embodiments, the identification process may be performed by the presentation by the customer of a card to the dispenser. The card in some preferable embodiments is a contactless card such as a radio frequency identification (RFID) card. Alternatively the card may be a contact card such as a credit card, driving license, or any other card capable of identifying the customer. Contact cards such as these may use magnetic stripes or chips having exposed contacts to pass details to the dispenser.

The various components of the present invention may communicate using any appropriate network. In a preferred embodiment, they are linked by a local area network though other known networks (such as the internet) may also be used to provide interaction between the various components. In particular, the dispenser and the control system may be connected to a local area network. Additionally, the service mechanism may also be connected to the local area network.

The present invention complements the existing services and materials available in retail environments. The content presented to the user does not intrude any other method of delivering customized advertisements to a user.

### BRIEF DESCRIPTION OF DRAWINGS

Examples of the present invention will now be described in detail with reference to the accompanying drawings, in which:

FIG. 1 is a schematic diagram of a preferred embodiment of the queue management system according to the invention; and

FIG. 2 illustrates an exemplary queue ticket.

### DETAILED DESCRIPTION

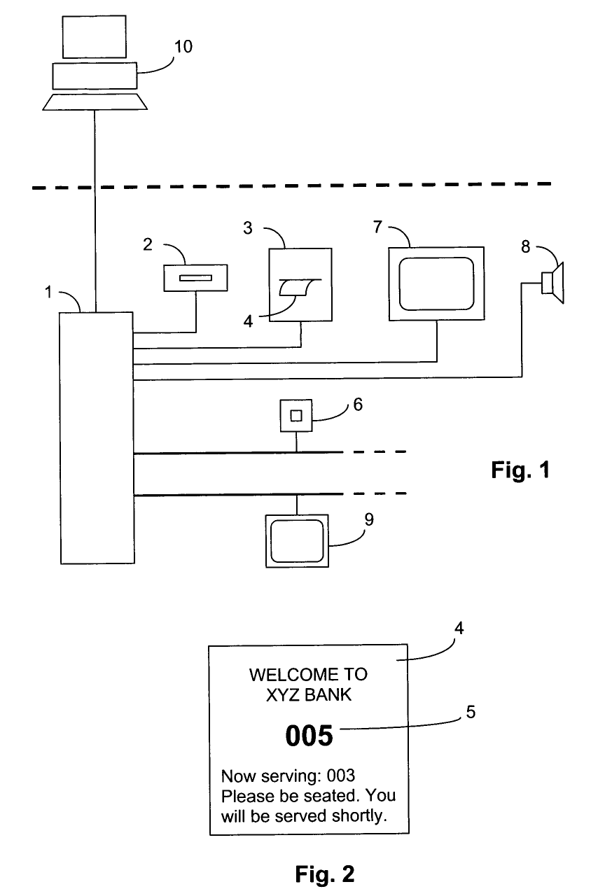

As shown in FIG. 1, the preferred embodiment of the present invention comprises a control means 1 which is connected to all other components of the system as well as to the establishment's computer system 10.

Upon entering the establishment, a customer approaches a ticket request means 2 to identify himself and to request for a queue ticket, whereupon the ticket request means 2 captures his identity and transmits it to the control means 1. The control means 1 allocates a customer reference to this customer and transmits the customer reference to a ticket dispenser 3 to issue a queue ticket 4 to the customer. The queue ticket 4, shown in FIG. 2, bears the customer reference which is typically in the form of a turn number 5. After obtaining the queue ticket 4, the customer proceeds to the waiting area to wait for his turn. In the meantime, the control means 1 communicates the customer's identity to the establishment's computer system 10. If the establishment's computer system 10 detects that this customer has been targeted for some promotion, the establishment's computer system 10 sends the relevant customized advertisement back to the control means 1 which then stores the information for later use.

Each service position is equipped with a customer request means 6 for the teller at that service position to call the next-in-turn customer. Each service position is further equipped with a customer interaction unit 9 for displaying information to the customer being served at that service position as well as for getting a response from the customer. When the teller at a particular service position activates his customer request means 6 to request a customer, the control means 1 checks its memory to determine the turn number of the next-in-turn customer to call. The control means 1 then sends the turn number and the service position to a customer advising means 7 installed at the waiting area such that it is visible by waiting customers. An audio output device 8 is also activated to attract the attention of the waiting customers. Upon seeing his turn number being displayed on the customer advising means 7, the customer with that turn number proceeds to the service position indicated to be served. If there is any customized advertisement stored earlier for this customer, the control means 1 will display the information on the customer interaction unit 9 located at that service position for the customer to view. If the customer wishes to respond to the information being displayed, he may do so via the customer interaction unit 9. Any response received by the customer interaction unit 9 is transmitted back to the control means 1 which in turn sends the response to the establishment's computer system 10 for further action.

The various components of the system in the preferred embodiment shall now be described in greater detail.

The control means 1 is a commercially available computer comprising, among other things, a monitor, keyboard, memory, hard disk, digital input/output (I/O) card, audio and video cards, and serial, parallel and local area network interfaces.

The ticket request means 2, which is typically mounted near the ticket dispenser 3, can be implemented in a number of ways depending on the identification means currently used by the establishment's computer system 10 to uniquely identify a customer. For example, some establishments may use biometrics such as fingerprint, eye retina or iris patterns to identify their customers in which case the ticket request means 2 shall comprise a corresponding biometrics reader. Other establishments may issue a machine-readable customer card bearing a unique customer identification number to each customer. Examples of such establishments are banks which issue credit cards and Automatic Teller Machine (ATM) cards to their customers. These cards may be in the form of magnetic stripe card, chip-based smart card and radio frequency identification (RFID) card. In such cases, the ticket request means 2 shall consist of a corresponding card reader or a combination of such card readers. The above-mentioned biometrics readers and card readers are all commercially available and well known in the art. They can be connected to the control means 1 via the serial interface or the local area network.

The ticket dispenser 3 can be any receipt printer used by cash registers at supermarket check-out counters. It can be connected to the control means 1 via the serial or parallel interface or the local area network.

The customer request means 6 may take a number of forms. For example, the customer request means may be a simple pushbutton connected to the digital I/O card in the control means 1. Alternatively, a more complex device, referred to hereinafter as a Counter Terminal, may be used to provide the ability to call the customer. The Counter Terminal may provide additional features and may incorporate a number of buttons and a display if required. A further alternative is for the customer request means to be implemented as Virtual Counter Terminal which is a software application running on a computer at the tellers position. The Virtual Counter terminal offers all the features of the conventional Counter Terminal. The computer may be connected to the queue system by a local area network.

Each of the customer interaction units 9 is typically a small (e.g. 25 cm) touch-screen LCD monitor connected to the control means 1 via the local area network. The customer advising means 7 is a similarly connected large (e.g. 100 cm) LCD monitor. The audio output device 8 may be a loudspeaker connected to the audio card in the control means 1 or alternatively may be a simple buzzer or other sound device (such as a door bell) connected to an output of the control means. Connecting the above components to a computer is well known in the art.

The operation of the system will now be described in greater detail for a single-service system based on the first-in-first-out queue discipline.

At the start of a business day, the control means 1 resets the current turn number in its memory to “000” and also initializes a Queue Table in its memory. The first column in the Queue Table stores turn numbers while the second column stores a corresponding flag indicating whether any information is available for the respective turn numbers, as shown below:

| | |
|---|---|
| Turn Number | Flag |

Upon arrival at the establishment, each customer presents his identification means to the ticket request means 2 to request a ticket. The ticket request means 2 captures the identity information from the customer's identification means and transmits the identity information to the control means 1. The control means 1, upon receiving the customer's identity information, increments the current turn number by one and stores this number in the first available blank entry in the Queue Table under the turn number column. It then sends this turn number as well as other necessary information to the ticket dispenser 3, which then dispenses a queue ticket 4 bearing the turn number, a sample of which is shown in FIG. 2. After taking the queue ticket 4, the customer proceeds to the waiting area to wait for his turn. The control means 1 then sends the customer's identity information to the establishment's computer system 10. If the establishment's computer system 10 detects that this customer has been targeted for some promotion, the establishment's computer system 10 sends the relevant advertisement page back to the control means 1, which then stores it in its hard disk using this turn number as the filename. The control means 1 also stores a “1” in the flag column corresponding to this turn number in the Queue Table. However, if this customer is not a targeted customer, the establishment's computer system 10 sends a message indicating so to the control means 1, which then stores a “0” in the flag column corresponding to this turn number in the Queue Table.

The above process is repeated for each customer who requests a queue ticket. The table below shows an example of the content of the Queue Table after four customers have taken their queue tickets, where the second and third customers are targeted customers:

| Turn Number | Flag |
|---|---|
| 001 | 0 |
| 002 | 1 |
| 003 | 1 |
| 004 | 0 |

When a teller at a particular service position is free to serve the next customer, he presses the pushbutton on his customer request means 6 to request a new customer. The control means 1, upon detecting the request from this particular service position, retrieves the turn number from the top of the Queue Table. It then sends the turn number and the service position to the customer advising means 7 for display. It also activates the audio output device 8 to produce an audible signal to attract the attention of waiting customers. The control means 1 then retrieves the flag from the top of the Queue Table. If the flag is “0”, the control means 1 displays a general welcome or greeting message on the customer interaction unit 9 located on the particular service position. On the other hand, if the flag is “1”, the control means 1 fetches the file with the turn number as filename from its hard disk and displays it on the customer interaction unit 9. In both cases, the control means 1 then deletes the turn number and the flag from the top of the Queue Table. It can also delete the file with the turn number as filename from its hard disk to conserve disk storage space. Upon seeing his turn number displayed on the customer advising means 7, the customer proceeds to the service position indicated to be served.

The above process is repeated each time a customer is served. While waiting for his transaction to be processed by the teller, a targeted customer can keep himself occupied by reading the advertisement displayed on the customer interaction unit 9 in front of him. The advertisement page typically includes instructions on how the customer can respond to the advertisement by touching different parts of the touch-screen to select different options. For example, the customer may request more information to be sent to him, or a sales representative to call him. His response, if any, is sent to the control means 1 for onward transmission to the establishment's computer system 10.

It is thus clear that the invention has achieved its stated objective of providing a queue management system capable of delivering customized electronic information to targeted customers being served at service positions. It also allows targeted customers to immediately respond to the information if he so wishes. Further, the system can provide a means which complements existing methods for establishments to deliver customized advertisements to targeted customers.

The invention described herein is susceptible to variations, modifications and/or additions other than those specifically described. For example, it is easy to extend the system to a multi-service system for use by establishments which offer more than one type of service over the counter. For example, a bank may ask customers to select among Savings Account, Current Account, Loan and Remittance transactions. In such a multi-service system, the ticket request means 2 shall have several pushbuttons, one for each type of service, for the customer to select a particular service. The control means 1 shall maintain in its memory a separate turn number sequence and Queue Table for each type of service. For this purpose, an extra digit or letter can be added to the front of the 3-digit turn number to distinguish the turn numbers for different services. The control means 1 shall also note the type of service offered by each service position so that turn number from the correct Queue Table shall be called when a particular teller requests a new customer.

Further, although the above description only talks about displaying advertisement to the customer, it is clear that the system can be used to display other information to the customer. Likewise, queue discipline other that the first-in-first-out method may be used. It is thus to be understood that the invention includes all variations, modifications and/or additions which fall within the scope of the following claims.

1. A queue management system comprising:
a dispenser adapted to acquire the identities of customers and to issue a customer reference for each customer, each customer reference representing the position of a respective customer within a queue;
a control system adapted to associate content with each customer reference in dependence on the identity acquired for that customer reference; and,
a service mechanism adapted to call the customer at the front of the queue to a service position and to display to that customer the content associated with that customer's customer reference at the service position.

2. A system according to claim 1, wherein the content is interactive and the service mechanism comprises an input device to allow the customer to interact with the content.

3. A system according to claim 2, wherein the input device is a touch-screen.

4. A system according to claim 1, wherein the dispenser is adapted to analyse biometric details in order to acquire the identity of the customer.

5. A system according to claim 1, wherein the dispenser comprises a card reader in order to acquire the identity of the customer.

6. A system according to claim 5, wherein the card reader is a contactless card reader.

7. A system according to claim 1, further comprising a local area network linking the dispenser and the control system.

8. A method for managing a queue, the method comprising:
acquiring the identities of a plurality of customers;
issuing a customer reference for each customer, each customer reference representing the position of a respective customer within the queue;
associating content with each customer reference in dependence on the identity acquired for that customer reference;
calling the customer at the front of the queue to a service position; and,
displaying the content associated with the customer reference of the customer at the front of the queue to that customer.

9. A method according to claim 8, wherein the content is interactive.

10. A method according to claim 8, wherein the step of acquiring the identity of the customer comprises analyzing biometric details of the customer.

11. A method according to claim 8, wherein the step of acquiring the identity of the customer comprises reading a card held by the customer.

12. A method according to claim 11, wherein the card is a contactless card.
